(19) United States
(12) Patent Application Publication
(10) Pub. No.: US 2025/0285402 A1
(43) Pub. Date: Sep. 11, 2025

(54) CONTROL DEVICE, OPERATION METHOD OF CONTROL DEVICE, OPERATION PROGRAM OF CONTROL DEVICE, IMAGING APPARATUS, AND DISPLAY APPARATUS

(71) Applicant: FUJIFILM Corporation, Tokyo (JP)

(72) Inventor: Masato FUJII, Saitama (JP)

(73) Assignee: FUJIFILM Corporation, Tokyo (JP)

(21) Appl. No.: 19/070,528

(22) Filed: Mar. 5, 2025

(30) Foreign Application Priority Data
Mar. 6, 2024 (JP) 2024-034377

(51) Int. Cl. G06V 10/25; G06V 20/52; H04N 7/18; H04N 23/66; H04N 23/69; H04N 23/695

(52) U.S. Cl. CPC G06V 10/25; G06V 20/52; H04N 7/183; H04N 23/66; H04N 23/69; H04N 23/695

(57) ABSTRACT

A subject detection region setting unit and a display/storage region image generation unit of a CPU of a controller of a surveillance camera set a subject detection region where subject detection processing is performed and a display/storage region where display/storage processing is performed, for a captured image. The subject detection region setting unit switches the subject detection region between the display/storage region, which is a first region, and an entire surface region, which is a second region having a different size and position from the display/storage region.

### CROSS-REFERENCE TO RELATED APPLICATIONS

The present application claims priority under 35 U.S.C. § 119 to Japanese Patent Application No. 2024-034377, filed on Mar. 6, 2024. The above application is hereby expressly incorporated by reference, in its entirety, into the present application.

### BACKGROUND

### 1. Technical Field

The technology of the present disclosure relates to a control device, an operation method of a control device, an operation program of a control device, an imaging apparatus, and a display apparatus.

### 2. Description of the Related Art

An image processing apparatus described in JP2010-136204A includes an image input unit that inputs image data, a subject detection unit that detects a specific subject from the image data input by the image input unit, a region determination unit that determines a region where the detection by the subject detection unit is performed, and a recording unit that records the image data input by the image input unit on a recording medium. The region determination unit switches a determination method for a region where the detection of the subject is performed, according to whether or not moving image data is being recorded by the recording unit.

### SUMMARY

One embodiment according to the technology of the present disclosure provides a control device, an operation method of a control device, an operation program of a control device, an imaging apparatus, and a display apparatus that are also capable of detecting a subject outside a region defined based on a specific region where specific processing is performed.

According to the present disclosure, there is provided a control device that performs subject detection processing and specific processing on a captured image obtained from an imaging element, the control device comprising: a processor, in which the processor is configured to: set a subject detection region where the subject detection processing is performed and a specific region where the specific processing is performed, for the captured image; and switch the subject detection region between a first region defined based on the specific region and a second region that is different from the first region in at least one of a size, a shape, or a position.

It is preferable that the second region has a larger region size than the first region.

It is preferable that the first region is the specific region, and the second region is an effective region of an imaging surface of the imaging element.

It is preferable that the processor is configured to: repeatedly switch the subject detection region between the first region and the second region.

It is preferable that the processor is configured to: switch the subject detection region to the second region in a case where a state in which no subject is detected continues for a first threshold value time after setting the subject detection region to the first region; and switch the subject detection region to the first region in a case where a state in which no subject is detected continues for a second threshold value time after setting the subject detection region to the second region.

It is preferable that the second threshold value time is different from the first threshold value time.

It is preferable that the second threshold value time is longer than the first threshold value time.

It is preferable that the control device is provided in a surveillance camera system including a pan mechanism, and the processor is configured to: switch the subject detection region from the second region to the first region in a case where the pan mechanism is operated while the subject detection region is the second region.

It is preferable that the processor is configured to: acquire brightness information indicating brightness of the first region and the second region; and switch the subject detection region to a region having higher brightness between the first region and the second region.

It is preferable that the processor is configured to: in a case where a subject is detected in the subject detection region, switch the subject detection region to a third region defined based on a detection result of the subject in a previous frame.

It is preferable that the third region is a region obtained by enlarging a region of the subject detected in the previous frame based on a set magnification factor, with a centroid of the region of the subject detected in the previous frame as a reference.

It is preferable that the processor is configured to: change the set magnification factor according to a movement speed of the detected subject in the captured image.

It is preferable that the processor is configured to: switch the subject detection region from the third region to the second region in a case where the subject detection region is set to the third region and a state in which no subject is detected continues for a third threshold value time.

It is preferable that the processor is configured to: perform, as the specific processing, at least one of processing related to display of an image of the specific region on a display unit or processing related to storage of the image of the specific region in a storage unit.

According to the present disclosure, there is provided an operation method of a control device that performs subject detection processing and specific processing on a captured image obtained from an imaging element, the operation method comprising: setting a subject detection region where the subject detection processing is performed and a specific region where the specific processing is performed, for the captured image; and switching the subject detection region between a first region defined based on the specific region and a second region that is different from the first region in at least one of a size, a shape, or a position.

According to the present disclosure, there is provided an operation program of a control device that performs subject detection processing and specific processing on a captured image obtained from an imaging element, the operation program causing a computer to perform a process comprising: setting a subject detection region where the subject detection processing is performed and a specific region where the specific processing is performed, for the captured image; and switching the subject detection region between a first region defined based on the specific region and a second region that is different from the first region in at least one of a size, a shape, or a position.

According to the present disclosure, there is provided an imaging apparatus comprising: the control device described above.

It is preferable that the imaging apparatus is a surveillance camera.

According to the present disclosure, there is provided a display apparatus comprising: the control device described above.

It is preferable that the display apparatus is a management apparatus of a surveillance camera system.

### BRIEF DESCRIPTION OF THE DRAWINGS

Exemplary embodiments according to the technique of the present disclosure will be described in detail based on the following figures, wherein:

FIG. 1 is a diagram showing a surveillance camera system;

FIG. 2 is a block diagram showing a computer that constitutes a management apparatus;

FIG. 3 is a diagram showing an internal configuration of a surveillance camera;

FIG. 4 is a diagram showing an imaging element;

FIG. 5 is a block diagram showing a computer that constitutes a controller;

FIG. 6 is a block diagram of a CPU;

FIG. 7 is a diagram showing a threshold value time group;

FIG. 8 is a diagram showing subject detection region setting information;

FIG. 9 is a diagram showing a situation in which a subject detection region image is input to a subject detection model and subject detection information is output from the subject detection model;

FIG. 10 is a diagram showing a situation in which a distribution image is generated;

FIG. 11 is a diagram showing a transition in setting a subject detection region in a subject undetected state;

FIG. 12 is a diagram showing a transition in setting the subject detection region in a case where a subject is detected;

FIG. 13 is a diagram showing a detection frame enlargement region;

FIG. 14 is a diagram showing a transition in setting the subject detection region in a case where a subject non-detection state continues for a third threshold value time;

FIG. 15 is a diagram showing a case where a plurality of persons are detected;

FIG. 16 is a diagram showing a case where a person and a detection frame are partially outside a display/storage region;

FIG. 17 is a flowchart showing an operation procedure of the surveillance camera;

FIG. 18 is a flowchart showing an operation procedure of the surveillance camera;

FIG. 19 is a flowchart showing an operation procedure of the surveillance camera;

FIG. 20 is a flowchart showing an operation procedure of the surveillance camera;

FIG. 21 is a flowchart showing an operation procedure of the surveillance camera;

FIG. 22 is a diagram showing a transition in setting the subject detection region in a second embodiment;

FIG. 23 is a diagram showing a processing unit of a third embodiment;

FIG. 24 is a diagram showing a transition in setting the subject detection region in the third embodiment;

FIG. 25 is a diagram showing a processing unit of a fourth embodiment;

FIGS. 26A and 26B are diagrams showing a situation in which a set magnification factor is changed according to a movement speed of the subject, in which FIG. 26A shows a case where the movement speed of the subject is less than a speed threshold value, and FIG. 26B shows a case where the movement speed of the subject is equal to or greater than the speed threshold value; and

FIG. 27 is a diagram showing a management apparatus incorporating a control device.

### DETAILED DESCRIPTION

### First Embodiment

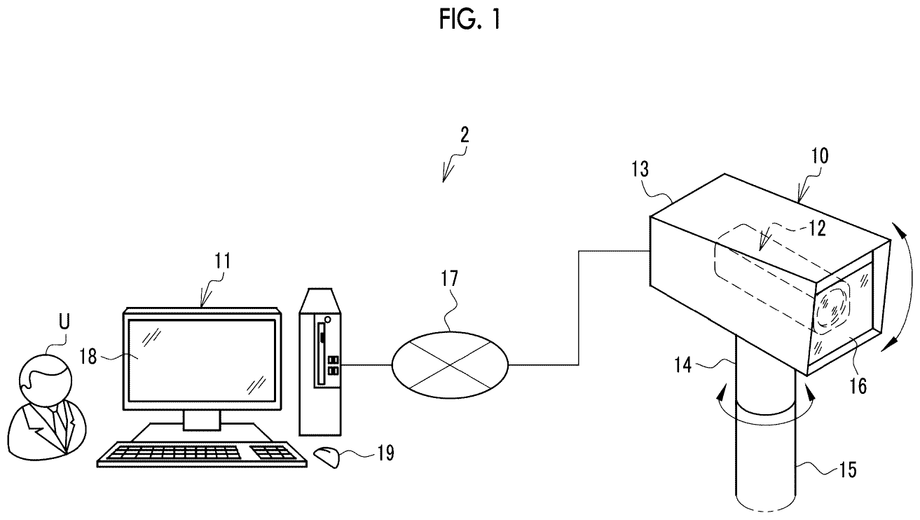

As shown in FIG. 1 as an example, a surveillance camera system 2 comprises a surveillance camera unit 10 and a management apparatus 11. The surveillance camera unit 10 is installed at various surveillance locations such as streets, private homes, apartment buildings, public facilities, office buildings, factories, construction sites, and work sites. The surveillance camera unit 10 includes a surveillance camera 12, a case 13, a pan and tilt mechanism 14, and a support post 15. The surveillance camera 12 captures a video of a surveillance location to surveil whether there are any suspicious persons or any incidents or accidents. The surveillance camera 12 is an example of an “imaging apparatus” according to the technology of the present disclosure.

The surveillance camera 12 is accommodated in the case 13. The case 13 is, for example, a highly sealed box-shaped container made of stainless steel and protects the surveillance camera 12 from direct sunlight, wind and rain, and the like. A transmission window 16 is fitted into a front opening of the case 13, and the surveillance camera 12 images the surveillance location through the transmission window 16.

The pan and tilt mechanism 14 is attached to a center of a lower surface of the case 13. The pan and tilt mechanism 14 revolves the case 13, and consequently the surveillance camera 12, by 360° endlessly in a horizontal direction in response to an operation by a user U of the surveillance camera system 2 through the management apparatus 11. In addition, the pan and tilt mechanism 14 tilts the case 13, and consequently the surveillance camera 12, by +90° in a vertical direction in response to an operation by the user U through the management apparatus 11. That is, an imaging region of the surveillance camera 12 can be changed in response to the operation by the user U. The pan and tilt mechanism 14 is an example of a “pan mechanism” according to the technology of the present disclosure.

The support post 15 is attached to a lower portion of the pan and tilt mechanism 14. The support post 15 is attached to an appropriate position of the surveillance location such as a utility pole, a gate post, a ceiling, or a wall.

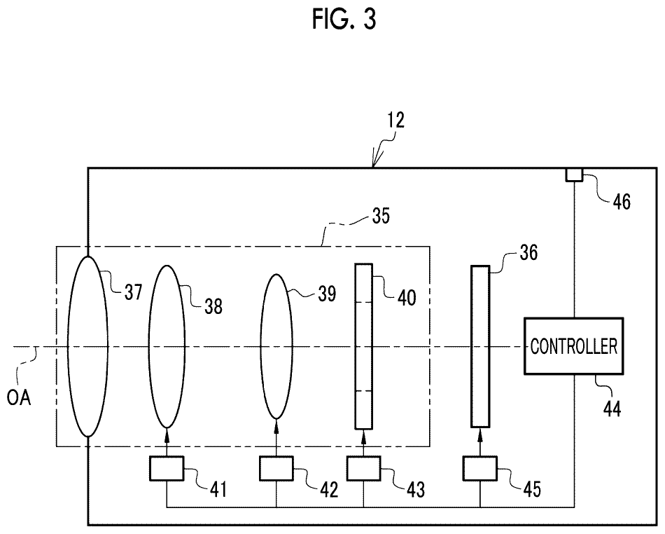

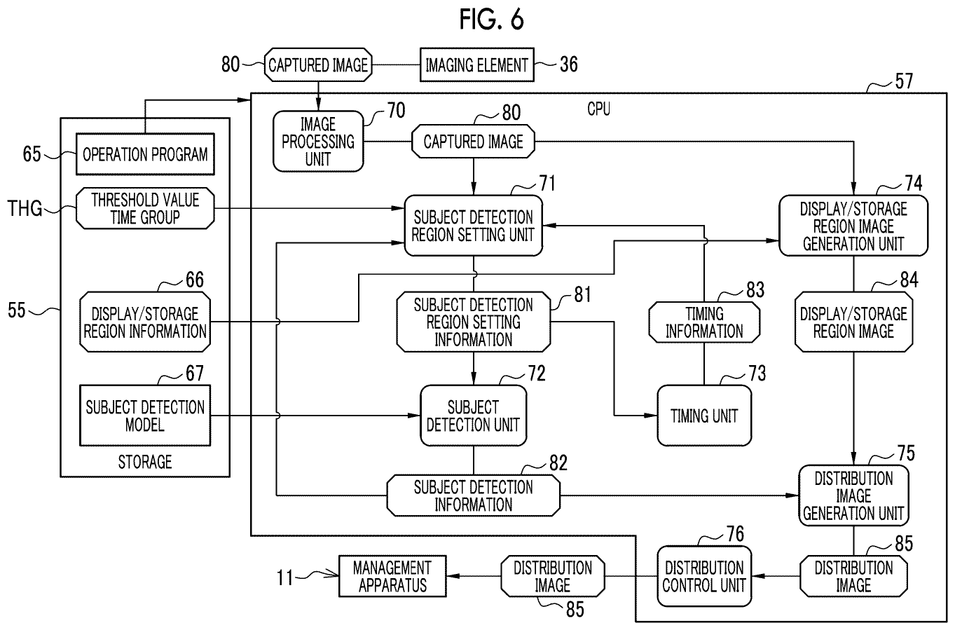

The surveillance camera unit 10 and the management apparatus 11 are connected to each other via a network 17 to communicate with each other. The network 17 is, for example, a wide area network (WAN) such as the Internet or a public communication network. The management apparatus 11 is installed in a control room or the like of a security company that comprehensively manages the surveillance camera system 2. The management apparatus 11 is operated by the user U such as an employee of the security company. The management apparatus 11 is, for example, a desktop type personal computer and includes a display 18 and an input device 19 such as a keyboard, a mouse, a touch panel, and/or a microphone for audio input. The display 18 mainly displays an image obtained by imaging the surveillance location with the surveillance camera 12, which is an image (distribution image 85 (refer to FIG. 6)) distributed from the surveillance camera 12 via the network 17. The display 18 is an example of a “display unit” according to the technology of the present disclosure. The input device 19 is operated by the user U to input various operation instructions. The operation instruction includes an imaging start instruction or an imaging end instruction of the surveillance camera 12, an operation instruction for the pan and tilt mechanism 14, a position change instruction (hereinafter, referred to as a zoom instruction) of a zoom lens 39 (refer to FIG. 3), which will be described below, and the like.

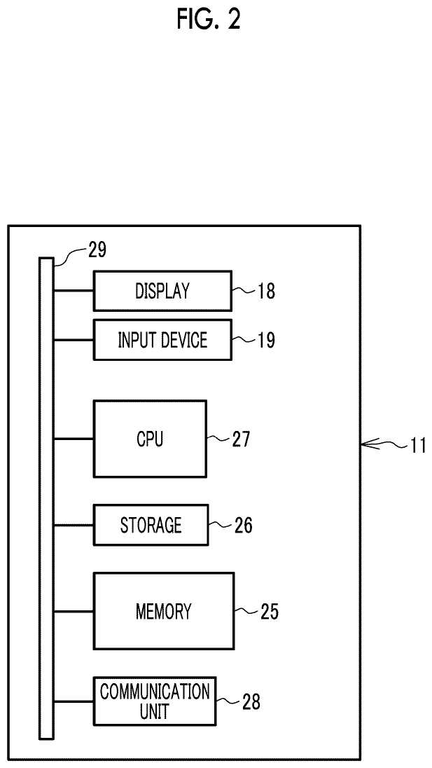

As shown in FIG. 2 as an example, a computer that constitutes the management apparatus 11 comprises a storage 25, a memory 26, a central processing unit (CPU) 27, and a communication unit 28, in addition to the display 18 and the input device 19 mentioned above. The display 18, the input device 19, the storage 25, the memory 26, the CPU 27, and the communication unit 28 are connected to each other via a busline 29.

The storage 25 is a hard disk drive that is incorporated into the computer that constitutes the management apparatus 11 or that is connected to the computer through a cable or a network. Alternatively, the storage 25 is a disk array equipped with a plurality of hard disk drives connected in series. The storage 25 stores a control program such as an operating system, various application programs, various types of data associated with these programs, and the like. Additionally, the storage 25 stores the distribution image 85. The storage 25 is an example of a “storage unit” according to the technology of the present disclosure. Note that a solid-state drive may be used instead of the hard disk drive.

The memory 26 is a work memory which is used for the CPU 27 to execute processing. The CPU 27 loads the program stored in the storage 25 into the memory 26 and executes processing in accordance with the program. Consequently, the CPU 27 comprehensively controls each unit of the computer. Note that the memory 26 may be incorporated into the CPU 27. The communication unit 28 is a network interface that controls transmission of various types of information to and from the surveillance camera unit 10 via the network 17.

As shown in FIG. 3 as an example, an imaging optical system 35 and an imaging element 36 are incorporated into the surveillance camera 12. The imaging optical system 35 includes a plurality of types of lenses for forming an image on the imaging element 36. Specifically, the imaging optical system 35 includes an objective lens 37, a focus lens 38, and the zoom lens 39. These lenses 37 to 39 are disposed in this order from an object side toward an image formation side. Although simplified in FIG. 1, each of the lenses 37 to 39 is actually a lens group composed of a plurality of lenses combined together.

The imaging optical system 35 also includes a stop 40. The stop 40 is disposed on the image formation side with respect to the zoom lens 39. The stop 40 is a so-called iris stop configured with a combination of a plurality of stop leaf blades.

A focus lens driving mechanism 41 is connected to the focus lens 38, a zoom lens driving mechanism 42 is connected to the zoom lens 39, and a stop driving mechanism 43 is connected to the stop 40. The focus lens driving mechanism 41 includes a focus cam ring that holds the focus lens 38 and that includes a cam groove formed on an outer circumference thereof, a focus motor that rotates the focus cam ring around an optical axis OA to move the focus cam ring along the optical axis OA, a driver of the focus motor, and the like. Similarly, the zoom lens driving mechanism 42 includes a zoom cam ring that holds the zoom lens 39 and that includes a cam groove formed on an outer circumference thereof, a zoom motor that rotates the zoom cam ring around the optical axis OA to move the zoom cam ring along the optical axis OA, a driver of the zoom motor, and the like.

The stop 40 adjusts an amount of light passing through by simultaneously moving the plurality of stop leaf blades using a cam mechanism to open and close a central opening formed by inner edges of the plurality of stop leaf blades, that is, to change an opening degree of the opening. The stop driving mechanism 43 includes a stop motor that opens and closes the stop leaf blades, a driver of the stop motor, and the like.

The focus motor, the zoom motor, and the stop motor are, for example, stepping motors. In this case, a position of the focus lens 38 and a position of the zoom lens 39 on the optical axis OA and the opening degree of the stop 40 can be derived from driving amounts of the focus motor, the zoom motor, and the stop motor. Alternatively, instead of the driving amounts of the focus motor and the zoom motor, a position sensor may be provided to detect the position of the focus lens 38 and the position of the zoom lens 39.

Electrical components such as the motor (the focus motor, the zoom motor, and the stop motor) or the driver of each of the driving mechanisms 41 to 43 are connected to a controller 44. The electrical components of each of the driving mechanisms 41 to 43 are driven under the control of the controller 44. For example, the controller 44 issues drive signals corresponding to various operation instructions input via the input device 19 of the management apparatus 11 to drive the electrical components of each of the driving mechanisms 41 to 43. As an example, in a case where a zoom instruction to change an angle of view to a telephoto side is input, the controller 44 issues a drive signal to the driver of the zoom motor of the zoom lens driving mechanism 42 to move the zoom lens 39 to the telephoto side.

The focus motor, the zoom motor, and the stop motor output the driving amounts to the controller 44. The controller 44 derives the position of the focus lens 38 and the position of the zoom lens 39 on the optical axis OA and the opening degree of the stop 40 from the driving amounts.

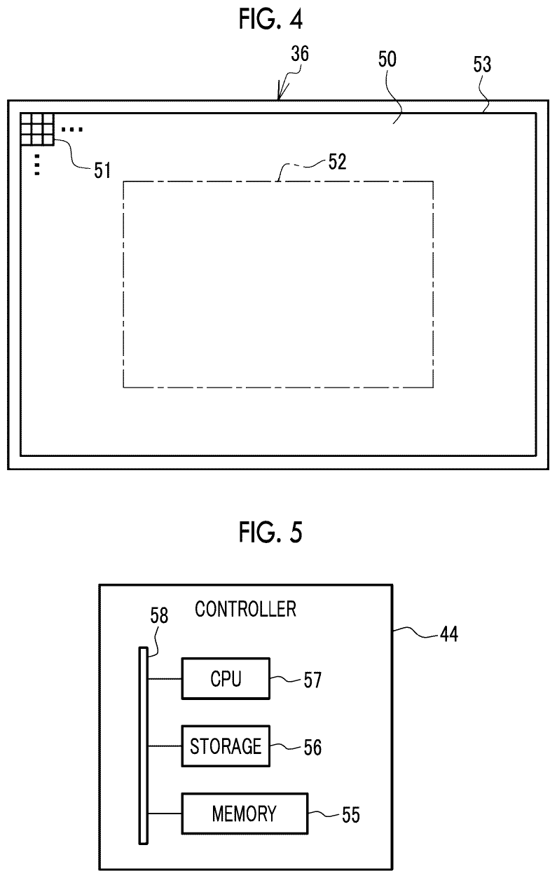

The imaging element 36 is, for example, a complementary metal-oxide-semiconductor (CMOS) image sensor. As shown in FIG. 4 as an example, the imaging element 36 includes a rectangular imaging surface 50 for capturing an image. The imaging surface 50 is formed by a plurality of pixels 51 arranged two-dimensionally. The pixel 51 accumulates signal charges corresponding to incident light and outputs an image signal (voltage signal) corresponding to the signal charges. The imaging element 36 is disposed such that a center of the imaging surface 50 matches the optical axis OA and the imaging surface 50 is orthogonal to the optical axis OA. It should be noted that the terms “match” and “orthogonal” used herein refer not only to completely matching and completely being orthogonal but also to matching and being orthogonal in a sense that includes an error generally acceptable within the technical field to which the technology of the present disclosure belongs.

Reference numeral 52 indicates a display/storage region. The display/storage region 52 is a region obtained by aligning a center thereof with a center of an entire surface region 53 (hereinafter, referred to as an entire surface region) of the imaging surface 50 and reducing the entire surface region 53 by a magnification set in advance. Therefore, it is obvious that the display/storage region 52 has a smaller region size than the entire surface region 53. In addition, the entire surface region 53 has a different size and position from the display/storage region 52. The display/storage region 52 is a region of the distribution image 85 that is distributed from the surveillance camera 12 to the management apparatus 11, displayed on the display 18, and stored in the storage 25. The display/storage region 52 is an example of a “specific region” according to the technology of the present disclosure. Additionally, the entire surface region 53 is an example of an “effective region” according to the technology of the present disclosure. Although the entire surface region 53 is exemplified as the effective region, the technology of the present disclosure is not limited thereto. A region that is slightly smaller (for example, by several pixels) than the entire surface region 53, specifically, a region that is preferably 80% or more, and more preferably 90% or more, of the entire surface region 53 may be the effective region.

In FIG. 3, an imaging element driver 45 is connected to the imaging element 36. The imaging element driver 45 is connected to the controller 44. The imaging element driver 45 controls an image capturing timing of the imaging element 36 by supplying a vertical scanning signal and a horizontal scanning signal to the imaging element 36 and the like, under the control of the controller 44. In addition, the imaging element driver 45 sets a gain corresponding to an International Organization for Standardization (ISO) sensitivity, which is a gain applied to the image signals output from the pixels 51.

A connector 46 is further connected to the controller 44. A cable for connection to the network 17 is attached to the connector 46.

As shown in FIG. 5 as an example, the controller 44 is implemented by a computer that includes a storage 55, a memory 56, and a CPU 57. The storage 55, the memory 56, and the CPU 57 are connected to each other via a busline 58. The controller 44 is an example of a “computer” and a “control device” according to the technology of the present disclosure. The storage 55, which is a non-transitory storage medium, is, for example, a non-volatile storage device such as an electrically erasable programmable read-only memory (EEPROM). The storage 55 stores various parameters and various programs. Alternatively, instead of the EEPROM, a ferroelectric random access memory (FeRAM) or a magnetoresistive random access memory (MRAM) may be used as the storage 55.

The memory 56 is, for example, a random access memory (RAM) or the like and temporarily stores various types of information. The CPU 57 loads the program stored in the storage 55 into the memory 56 and executes processing in accordance with the program, thereby comprehensively controlling the operation of each unit of the surveillance camera 12. The CPU 57 is an example of a “processor” according to the technology of the present disclosure. Note that the memory 56 may be incorporated into the CPU 57.

As shown in FIG. 6 as an example, an operation program 65 is stored in the storage 55. The operation program 65 is an application program for causing the computer that constitutes the controller 44 to function as the control device. That is, the operation program 65 is an example of an “operation program of a control device” according to the technology of the present disclosure. In addition to the operation program 65, the storage 55 also stores a threshold value time group THG, display/storage region information 66, a subject detection model 67, and the like.

In a case where the operation program 65 is activated, the CPU 57 functions as an image processing unit 70, a subject detection region setting unit 71, a subject detection unit 72, a timing unit 73, a display/storage region image generation unit 74, a distribution image generation unit 75, and a distribution control unit 76 in cooperation with the memory 56 and the like.

The image processing unit 70 acquires a captured image 80 output from the imaging element 36. The captured image 80 is composed of image signals of all the pixels 51 of the imaging element 36, that is, image signals of the entire surface region 53. The image processing unit 70 performs various types of image processing on the captured image 80. The various types of image processing are, for example, offset correction processing, sensitivity correction processing, pixel interpolation processing, white balance correction processing, gamma correction processing, demosaicing processing, brightness signal and color difference signal generation processing, contour enhancement processing, color correction processing, and the like. The image processing unit 70 outputs the captured image 80 after various types of image processing to the subject detection region setting unit 71 and the display/storage region image generation unit 74.

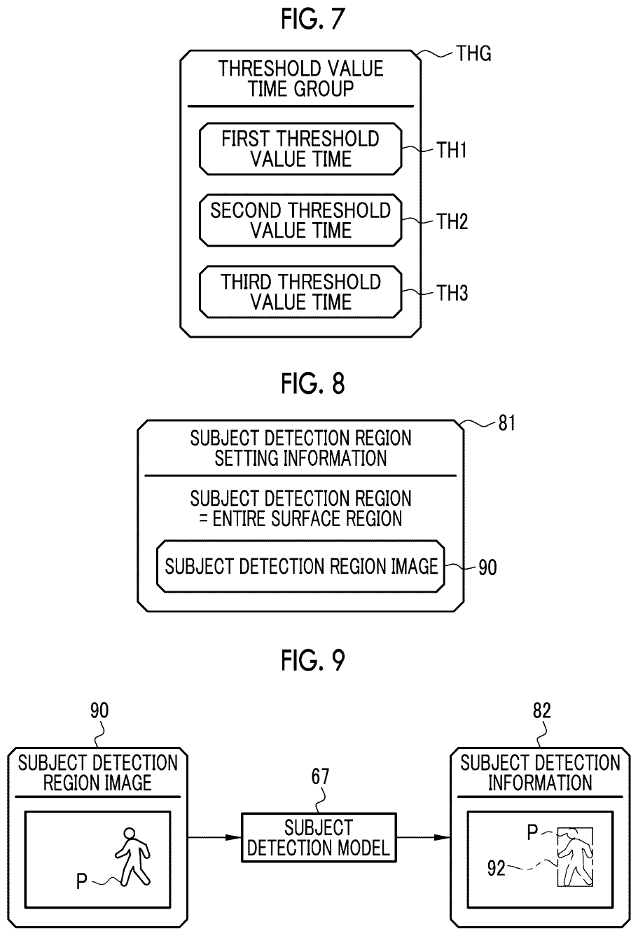

The subject detection region setting unit 71 sets a region (hereinafter, referred to as a subject detection region) where a subject is detected by the subject detection unit 72. The threshold value time group THG is input to the subject detection region setting unit 71. As shown in FIG. 7 as an example, the threshold value time group THG includes a first threshold value time TH1, a second threshold value time TH2, and a third threshold value time TH3.

The subject detection region setting unit 71 extracts the portion of the subject detection region from the captured image 80 to generate a subject detection region image 90 (refer to FIG. 8). The subject detection region setting unit 71 outputs subject detection region setting information 81 including the subject detection region image 90 to the subject detection unit 72 and the timing unit 73. As shown in FIG. 8 as an example, the subject detection region setting information 81 includes the set subject detection region in addition to the subject detection region image 90.

The subject detection unit 72 performs subject detection processing. That is, the subject detection unit 72 uses the subject detection model 67 to detect the subject present in the subject detection region set by the subject detection region setting unit 71. More specifically, as shown in FIG. 9 as an example, the subject detection unit 72 inputs the subject detection region image 90 to the subject detection model 67 and causes the subject detection model 67 to output subject detection information 82. The subject detection model 67 is, for example, a machine learning model such as a convolutional neural network. The subject detection information 82 is an example of a “detection result of the subject” according to the technology of the present disclosure.

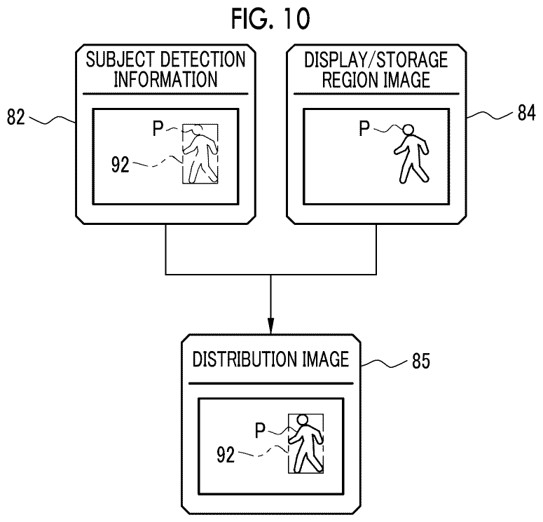

As shown in the drawing, in a case where a target subject, here, a person P, is captured in the subject detection region image 90, position coordinates of a rectangular detection frame (referred to as a bounding box) 92 surrounding the person P are registered in the subject detection information 82. On the other hand, in a case where no person P is captured in the subject detection region image 90, nothing is registered in the subject detection information 82. The detection frame 92 is an example of a “region of the subject detected” according to the technology of the present disclosure. The subject detection unit 72 outputs the subject detection information 82 to the subject detection region setting unit 71 and the distribution image generation unit 75. In FIG. 9, for convenience of description, the person P is depicted with a dashed line in the subject detection information 82. The same applies to subsequent figures such as FIG. 10.

The timing unit 73 measures various times to be compared with the threshold value time group THG. The timing unit 73 outputs timing information 83 to the subject detection region setting unit 71.

The display/storage region information 66 is information for defining the display/storage region 52 and is, for example, position coordinates of two pixels 51 diagonally located at an upper left corner and a lower right corner of the display/storage region 52. The display/storage region image generation unit 74 performs display/storage processing based on the display/storage region information 66. That is, the display/storage region image generation unit 74 generates a display/storage region image 84 by extracting the portion of the display/storage region 52 from the captured image 80 based on the display/storage region information 66. In this way, the processing of generating the display/storage region image 84 by the display/storage region image generation unit 74 is an example of “specific processing”, “processing related to display”, and “processing related to storage” according to the technology of the present disclosure. Additionally, the display/storage region image 84 is an example of an “image of a specific region” according to the technology of the present disclosure. The display/storage region image generation unit 74 outputs the display/storage region image 84 to the distribution image generation unit 75.

The distribution image generation unit 75 generates the distribution image 85 based on the subject detection information 82 and the display/storage region image 84. More specifically, as shown in FIG. 10, the distribution image generation unit 75 generates the distribution image 85 by combining the detection frame 92 registered in the subject detection information 82 with the display/storage region image 84. The distribution image generation unit 75 outputs the distribution image 85 to the distribution control unit 76. The distribution control unit 76 performs control of distributing the distribution image 85 to the management apparatus 11.

Each of the processing units 70 to 76 performs each processing described above, each time the captured image 80 is input from the imaging element 36. Meanwhile, a frame rate of the captured image 80 is, for example, 15 to 60 frames per second (fps).

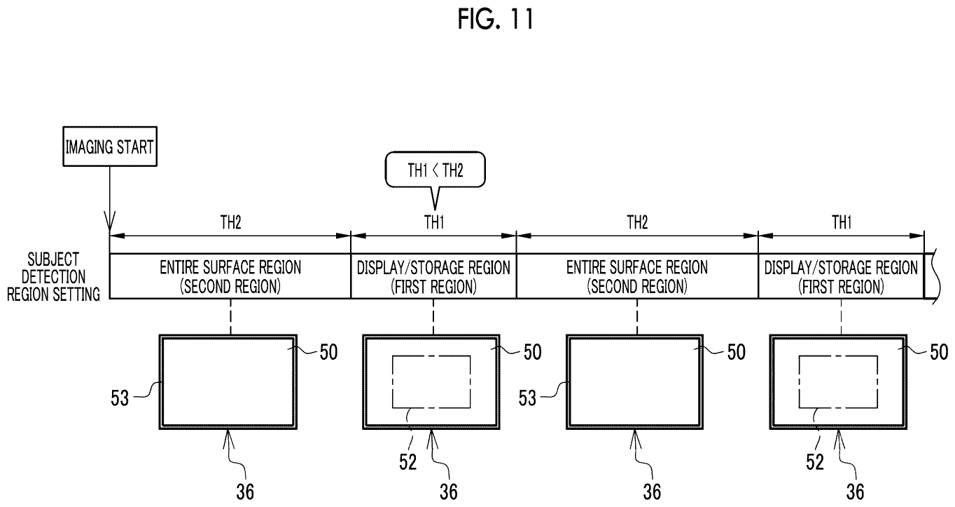

As shown in FIG. 11 as an example, in a case where the imaging start instruction of the surveillance camera 12 is issued by the user U via the input device 19 and the imaging of the surveillance location by the surveillance camera 12 is started, the subject detection region setting unit 71 sets the subject detection region to the entire surface region 53. In this case, the entire surface region 53 is registered in the subject detection region of the subject detection region setting information 81 as illustrated in FIG. 8. In addition, the captured image 80 is registered in the subject detection region image 90 of the subject detection region setting information 81. The entire surface region 53 is an example of a “second region” according to the technology of the present disclosure.

The timing unit 73 measures a time for which the subject detection region is set to the entire surface region 53 by the subject detection region setting unit 71 (hereinafter, referred to as a setting time of the entire surface region 53) and outputs the timing information 83 to the subject detection region setting unit 71 at predetermined intervals. The subject detection region setting unit 71 compares the setting time of the entire surface region 53 of the timing information 83 with the second threshold value time TH2. Then, in a case where the setting time of the entire surface region 53 continues for the second threshold value time TH2, the subject detection region is switched from the entire surface region 53 to the display/storage region 52. The second threshold value time TH2 is, for example, 1 minute. In this case, the display/storage region 52 is registered in the subject detection region of the subject detection region setting information 81. In addition, the display/storage region image 84 is registered in the subject detection region image 90 of the subject detection region setting information 81. The display/storage region 52 is an example of a “first region” according to the technology of the present disclosure.

The timing unit 73 measures a time for which the subject detection region is set to the display/storage region 52 by the subject detection region setting unit 71 (hereinafter, referred to as a setting time of the display/storage region 52) and outputs the timing information 83 to the subject detection region setting unit 71 at predetermined intervals. The subject detection region setting unit 71 compares the setting time of the display/storage region 52 of the timing information 83 with the first threshold value time TH1. Then, in a case where the setting time of the display/storage region 52 continues for the first threshold value time TH1, the subject detection region is switched again from the display/storage region 52 to the entire surface region 53. The first threshold value time TH1 is shorter than the second threshold value time TH2 and is, for example, 45 seconds. The subject detection region setting unit 71 repeatedly switches the subject detection region alternately between the display/storage region 52 and the entire surface region 53 as long as a state in which no subject is detected by the subject detection unit 72 (hereinafter, referred to as a subject undetected state) continues.

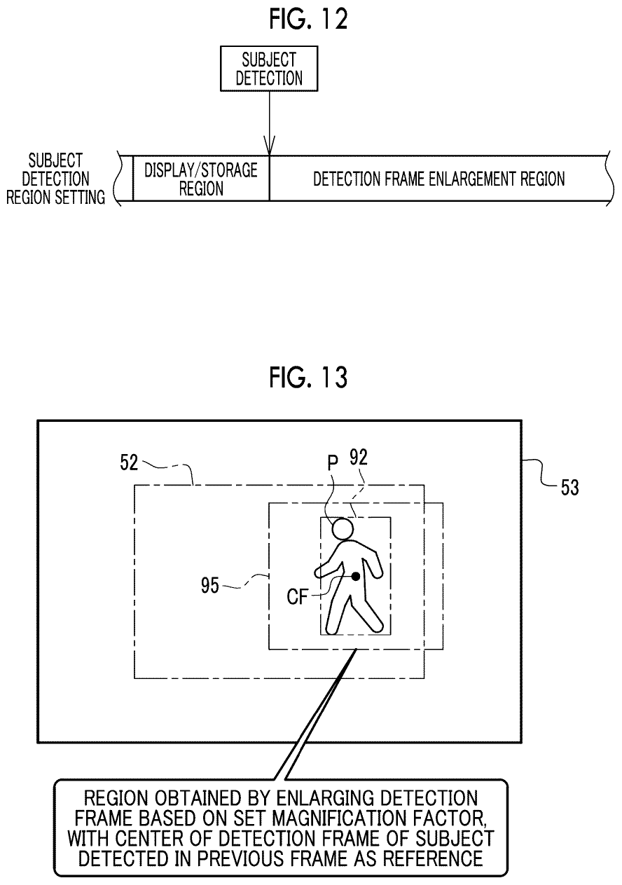

As shown in FIG. 12 as an example, in a case where the subject detection region is set to the display/storage region 52 or the entire surface region 53 and the subject is detected by the subject detection unit 72, the subject detection region setting unit 71 switches the subject detection region from the display/storage region 52 or the entire surface region 53 to a detection frame enlargement region 95 (refer to FIG. 13). A maximum value of a size of the detection frame enlargement region 95 is the entire surface region 53. In FIG. 12, a case where the display/storage region 52 is switched to the detection frame enlargement region 95 is illustrated. The detection frame enlargement region 95 is an example of a “third region” according to the technology of the present disclosure. In the following description, a case where the subject is detected by the subject detection unit 72 will be referred to as a subject detection state.

As shown in FIG. 13 as an example, the detection frame enlargement region 95 is a region obtained by enlarging the detection frame 92 based on the set magnification factor, with a center CF of the detection frame 92 of the subject detected in a previous frame as a reference. Here, the detection frame enlargement region 95 is a region where vertical sides of the detection frame 92 are scaled by 1.25 times and horizontal sides are scaled by 2.5 times. In this case, 1.25 times and 2.5 times are examples of a “set magnification factor” according to the technology of the present disclosure. Additionally, the center CF of the detection frame 92 is an example of a “centroid of the region of the subject” according to the technology of the present disclosure. As can be seen from the example of FIG. 13, the detection frame enlargement region 95 may protrude from the display/storage region 52 depending on the position of the original detection frame 92.

In a case where the person P is moving, the position and/or the size of the detection frame 92 changes with the movement of the person P. Therefore, the position and/or the size of the detection frame enlargement region 95 set based on the detection frame 92 also changes with the movement of the person P.

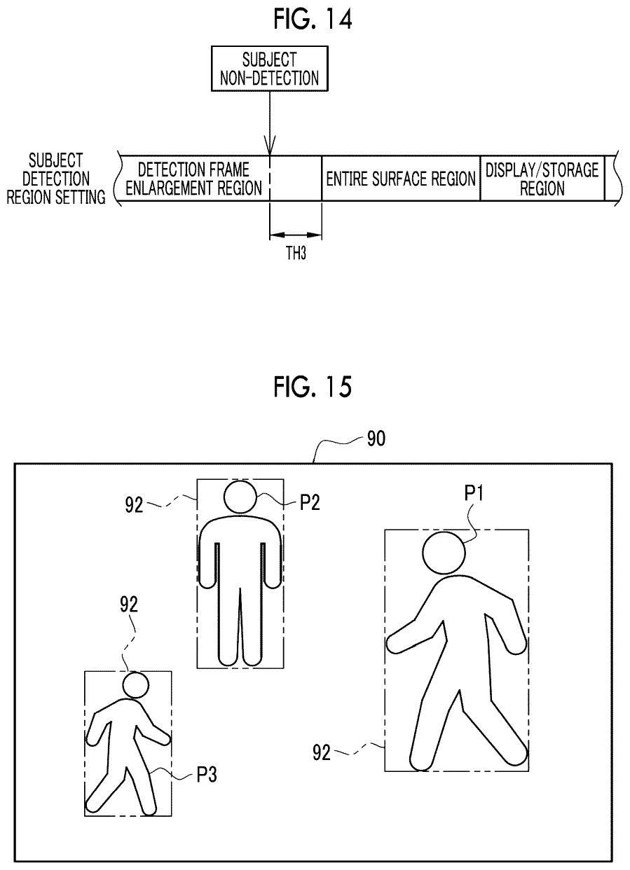

As shown in FIG. 14 as an example, in a case where the subject detection region is set to the detection frame enlargement region 95 and a state in which no subject is detected by the subject detection unit 72 (hereinafter, referred to as a subject non-detection state) occurs, the timing unit 73 measures a duration of the subject non-detection state and outputs the timing information 83 to the subject detection region setting unit 71 at predetermined intervals. The subject detection region setting unit 71 compares the duration of the subject non-detection state of the timing information 83 with the third threshold value time TH3. Then, in a case where the subject non-detection state continues for the third threshold value time TH3, the subject detection region is switched from the detection frame enlargement region 95 to the entire surface region 53. The subject non-detection state occurs in a case where the entire body of the person P is no longer captured in the captured image 80 (in a case where the entire body of the person P moves outside the entire surface region 53). During the period from when the subject non-detection state occurs until the third threshold value time TH3 has elapsed, the subject detection region setting unit 71 continues to set the subject detection region to the detection frame enlargement region 95 set immediately before the subject non-detection state occurs. The third threshold value time TH3 is shorter than the first threshold value time TH1 and the second threshold value time TH2 and is, for example, 5 seconds. After switching the subject detection region from the detection frame enlargement region 95 to the entire surface region 53, the subject detection region setting unit 71 repeatedly switches the subject detection region between the display/storage region 52 and the entire surface region 53.

Here, the subject undetected state can be rephrased as a state from when the imaging of the surveillance location by the surveillance camera 12 is started until the subject is first detected by the subject detection unit 72. In addition, the subject undetected state can be rephrased as a state from when the subject detection region is switched from the detection frame enlargement region 95 to the entire surface region 53, after the subject detection region has been set to the detection frame enlargement region 95 and the subject non-detection state has continued for the third threshold value time TH3 or longer, until the subject is detected again by the subject detection unit 72.

In FIG. 9, a case where only one person P is captured in the subject detection region image 90 has been illustrated, but the technology of the present disclosure is not limited thereto. As shown in FIG. 15 as an example, in a case where a plurality of persons P, here, three persons P1, P2, and P3, are captured in the subject detection region image 90, the subject detection model 67 detects the persons P1 to P3 and outputs the subject detection information 82 in which the position coordinates of the detection frames 92 of the persons P1 to P3 are registered. In such a case, the subject detection region setting unit 71 sets the detection frame enlargement region 95 for each of the persons P1 to P3. Therefore, the detection frame enlargement region 95 may partially overlap with another detection frame enlargement region 95.

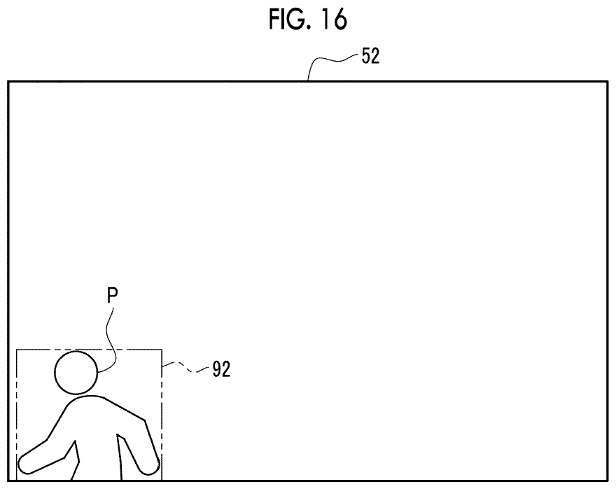

In addition, in FIG. 10, a case where the person P and the detection frame 92 fit within the display/storage region 52 has been illustrated, but the technology of the present disclosure is not limited thereto. As shown in FIG. 16 as an example, the person P and the detection frame 92 may be partially outside the display/storage region 52. For example, in a case where only the head of the person P is captured in the display/storage region 52, the detection frame 92 may be changed to a small frame that surrounds only the head of the person P rather than the entire body of the person P.

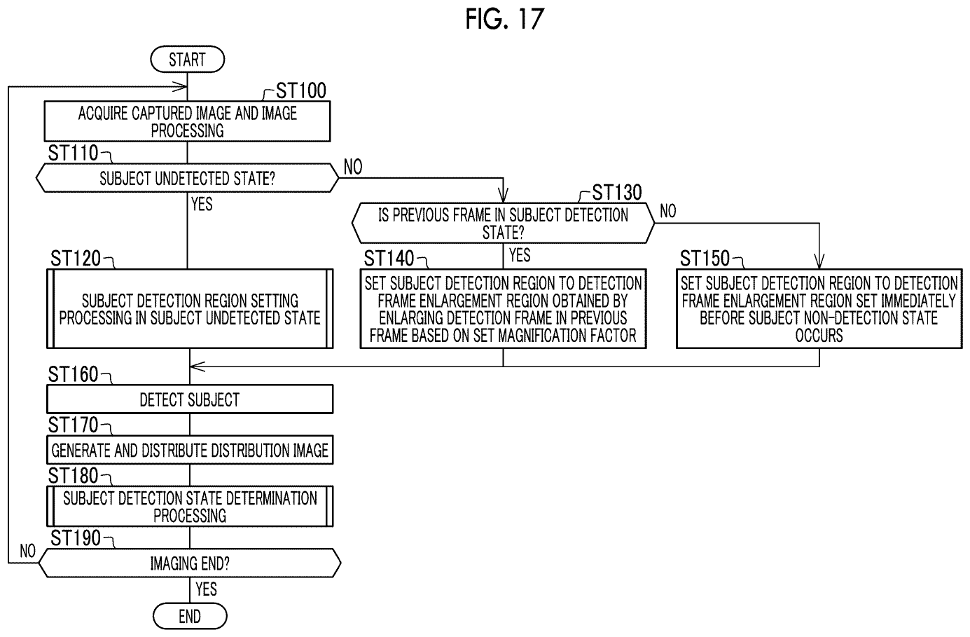

Next, operations of the above-described configuration will be described with reference to flowcharts shown in FIGS. 17, 18, 19, 20, and 21 as an example. In a case where the operation program 65 is activated in the surveillance camera 12, as shown in FIG. 6, the CPU 57 of the controller 44 of the surveillance camera 12 functions as the image processing unit 70, the subject detection region setting unit 71, the subject detection unit 72, the timing unit 73, the display/storage region image generation unit 74, the distribution image generation unit 75, and the distribution control unit 76.

In the management apparatus 11, in a case where the imaging start instruction of the surveillance camera 12 is issued by the user U via the input device 19 and the imaging of the surveillance location by the surveillance camera 12 is started, the captured image 80 of the surveillance location is output from the imaging element 36. The captured image 80 is input to the image processing unit 70, and various types of image processing are performed by the image processing unit 70 (step ST100 in FIG. 17). The captured image 80 after various types of image processing is output from the image processing unit 70 to the subject detection region setting unit 71 and the display/storage region image generation unit 74.

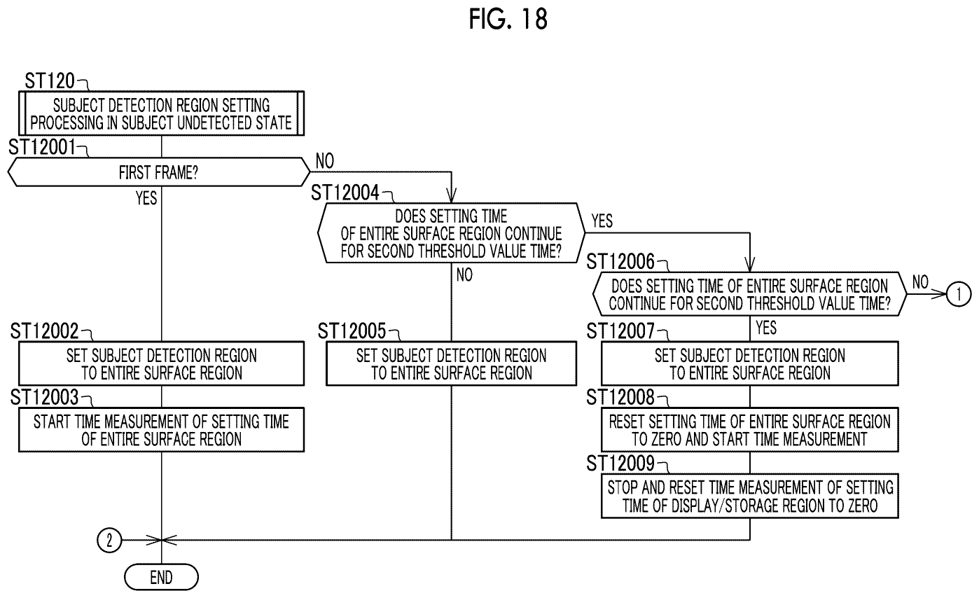

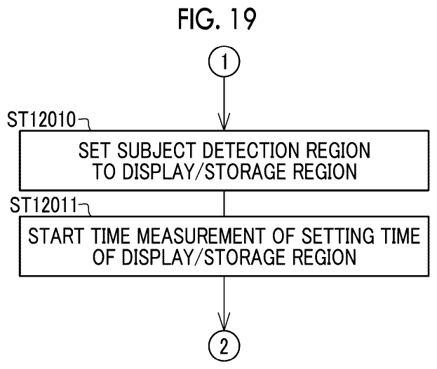

In a case where the state of the surveillance camera 12 is the subject undetected state (YES in step ST110), subject detection region setting processing in the subject undetected state is performed by the subject detection region setting unit 71 (step ST120). Details of the subject detection region setting processing in the subject undetected state will be described with reference to FIGS. 18 and 19. On the other hand, in a case where the state of the surveillance camera 12 is not the subject undetected state (NO in step ST110), the processing transitions to step ST130.

In a case where the subject is detected in the previous frame by the subject detection unit 72, that is, in a case where the previous frame is in the subject detection state (YES in step ST130), as shown in FIGS. 12 and 13, the subject detection region setting unit 71 sets the subject detection region to the detection frame enlargement region 95 obtained by enlarging the detection frame 92 based on the set magnification factor, with the center CF of the detection frame 92 of the subject detected in the previous frame as a reference (step ST140). On the other hand, in a case where no subject is detected in the previous frame by the subject detection unit 72, that is, in a case where the previous frame is in the subject non-detection state (NO in step ST130), the subject detection region setting unit 71 sets the subject detection region to the detection frame enlargement region 95 set immediately before the subject non-detection state occurs (step ST150).

In a case where the subject detection region is set by the subject detection region setting unit 71, the subject detection region setting information 81 shown in FIG. 8 is generated. The subject detection region setting information 81 is output from the subject detection region setting unit 71 to the subject detection unit 72 and the timing unit 73.

The subject present in the subject detection region is detected by the subject detection unit 72 (step ST160). More specifically, as shown in FIG. 9, the subject detection region image 90 is input to the subject detection model 67, and the subject detection information 82 is output from the subject detection model 67. The subject detection information 82 is output from the subject detection unit 72 to the subject detection region setting unit 71 and the distribution image generation unit 75.

The display/storage region image generation unit 74 generates the display/storage region image 84 by extracting the portion of the display/storage region 52 from the captured image 80 based on the display/storage region information 66. The display/storage region image 84 is output from the display/storage region image generation unit 74 to the distribution image generation unit 75.

As shown in FIG. 10, the distribution image generation unit 75 generates the distribution image 85 by combining the detection frame 92 registered in the subject detection information 82 with the display/storage region image 84. The distribution image 85 is output from the distribution image generation unit 75 to the distribution control unit 76 and is distributed to the management apparatus 11 under the control of the distribution control unit 76 (step ST170).

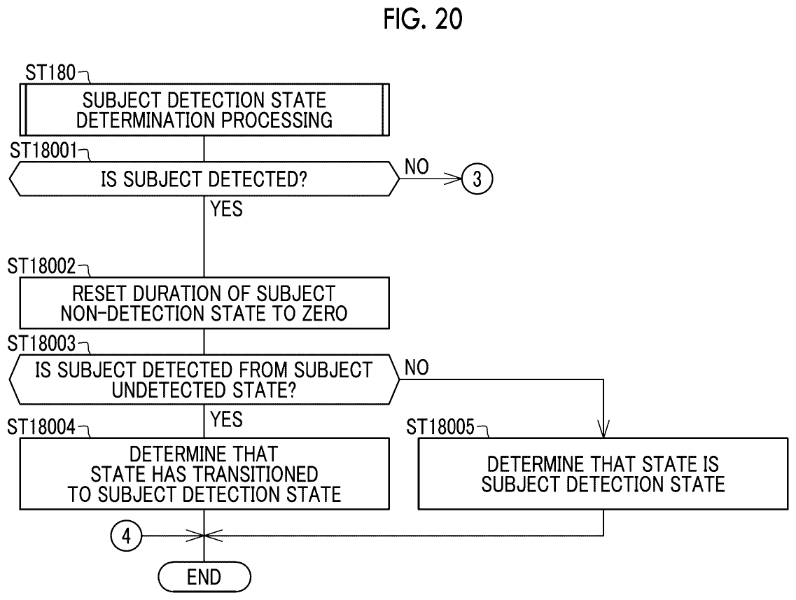

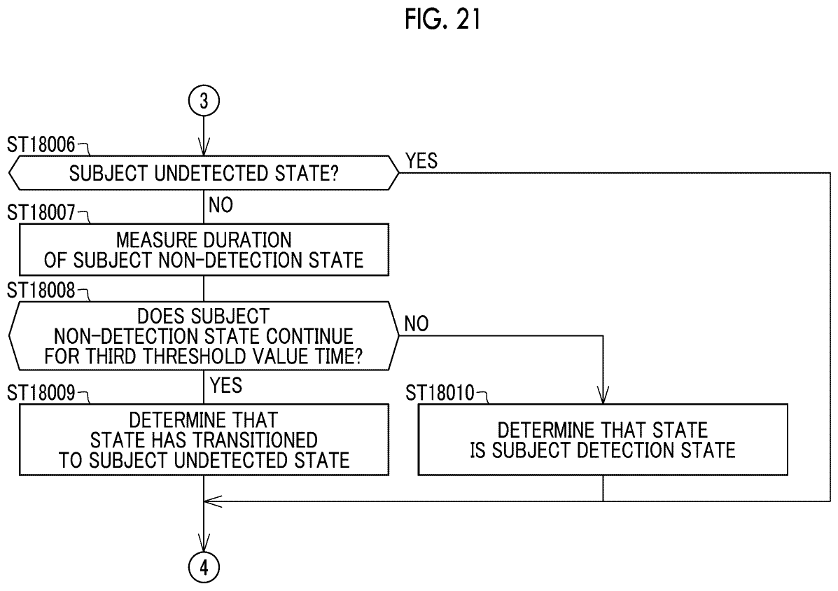

Subsequently, subject detection state determination processing is performed by the subject detection region setting unit 71 (step ST180). Details of the subject detection state determination processing will be described with reference to FIGS. 20 and 21.

Each processing of steps ST100 to ST180 is repeatedly performed until the imaging end instruction of the surveillance camera 12 is issued by the user U via the input device 19 and the imaging of the surveillance location by the surveillance camera 12 has not ended (NO in step ST190), in the management apparatus 11.

FIGS. 18 and 19 show a procedure of the subject detection region setting processing in the subject undetected state in step ST120. First, in a case where it is the first frame immediately after the imaging of the surveillance location by the surveillance camera 12 is started (YES in step ST12001), the subject detection region is set to the entire surface region 53 by the subject detection region setting unit 71 as shown in FIG. 11 (step ST12002). Then, the timing unit 73 starts the time measurement of the setting time of the entire surface region 53 (step ST12003).

In a case where it is the second or subsequent frame (NO in step ST12001), the subject detection region setting unit 71 compares the setting time of the entire surface region 53 of the timing information 83 with the second threshold value time TH2 and determines whether or not the setting time of the entire surface region 53 continues for the second threshold value time TH2 (step ST12004). In a case where the setting time of the entire surface region 53 does not continue for the second threshold value time TH2 (NO in step ST12004), the subject detection region is set to the entire surface region 53 by the subject detection region setting unit 71 (step ST12005). On the other hand, in a case where the setting time of the entire surface region 53 continues for the second threshold value time TH2 (YES in step ST12004), the processing transitions to step ST12006.

In step ST12006, the subject detection region setting unit 71 compares the setting time of the display/storage region 52 of the timing information 83 with the first threshold value time TH1 and determines whether or not the setting time of the display/storage region 52 continues for the first threshold value time TH1. In a case where the setting time of the display/storage region 52 continues for the first threshold value time TH1 (YES in step ST12006), the subject detection region is set to the entire surface region 53 by the subject detection region setting unit 71 (step ST12007). In other words, the subject detection region is switched from the display/storage region 52 to the entire surface region 53. Then, the timing unit 73 resets the setting time of the entire surface region 53 of the timing information 83 to zero and starts the time measurement of the setting time of the entire surface region 53 (step ST12008). Additionally, the time measurement of the setting time of the display/storage region 52 is stopped, and the setting time of the display/storage region 52 of the timing information 83 is reset to zero (step ST12009).

In a case where the setting time of the display/storage region 52 does not continue for the first threshold value time TH1 (NO in step ST12006), the subject detection region is set to the display/storage region 52 by the subject detection region setting unit 71 (step ST12010). In other words, the subject detection region is switched from the entire surface region 53 to the display/storage region 52. Then, the timing unit 73 starts the time measurement of the setting time of the display/storage region 52 (step ST12011).

FIGS. 20 and 21 show a procedure of the subject detection state determination processing of step ST180. First, in a case where the subject is detected in step ST160 (YES in step ST18001), the timing unit 73 resets the duration of the subject non-detection state of the timing information 83 to zero (step ST18002).

In a case where the subject detected in step ST160 is the subject detected from the subject undetected state (YES in step ST18003), the subject detection region setting unit 71 determines that the state of the surveillance camera 12 has transitioned from the subject undetected state to the subject detection state (step ST18004). On the other hand, in a case where the subject detected in step ST160 is not the subject detected from the subject undetected state (NO in step ST18003), the subject detection region setting unit 71 determines that the state of the surveillance camera 12 is the subject detection state (step ST18005). A case where the subject detected in step ST160 is not the subject detected from the subject undetected state refers to a case where the subject detection region is set to the detection frame enlargement region 95 and the subject is captured in the detection frame enlargement region 95.

In a case where no subject is detected in step ST160 (NO in step ST18001), the processing transitions to step ST18006. In step ST18006, the subject detection region setting unit 71 determines whether or not the state of the surveillance camera 12 is the subject undetected state. In a case where the state of the surveillance camera 12 is not the subject undetected state (NO in step ST18006), the timing unit 73 measures the duration of the subject non-detection state (step ST18007). A case where no subject is detected in step ST160 and the state of the surveillance camera 12 is not the subject undetected state refers to a case where the subject detection region is set to the detection frame enlargement region 95 and no subject is captured in the detection frame enlargement region 95.

In subsequent step ST18008, the subject detection region setting unit 71 compares the duration of the subject non-detection state of the timing information 83 with the third threshold value time TH3 and determines whether or not the subject non-detection state continues for the third threshold value time TH3. In a case where the subject non-detection state continues for the third threshold value time TH3 (YES in step ST18008), the subject detection region setting unit 71 determines that the state of the surveillance camera 12 has transitioned from the subject detection state to the subject undetected state (step ST18009). On the other hand, in a case where the subject non-detection state does not continue for the third threshold value time TH3 (NO in step ST18008), the subject detection region setting unit 71 determines that the state of the surveillance camera 12 is the subject detection state (step ST18010). The state (subject detection state or subject undetected state) of the surveillance camera 12 determined in the subject detection state determination processing of step ST180 is used for the determination of step ST110 of the next frame.

As described above, the subject detection region setting unit 71 and the display/storage region image generation unit 74 of the CPU 57 of the controller 44 of the surveillance camera 12 set the subject detection region where the subject detection processing is performed and the display/storage region 52 where the display/storage processing is performed, for the captured image 80. The subject detection region setting unit 71 switches the subject detection region between the display/storage region 52, which is the first region, and the entire surface region 53, which is the second region having a different size and position from the display/storage region 52. Therefore, it is also possible to detect the subject outside the display/storage region 52.

As shown in FIG. 4, the entire surface region 53 has a larger region size than the display/storage region 52. Therefore, it is possible to detect the subject present in the entire surface region 53 having a larger region size than the display/storage region 52. In addition, even for the same subject, the subject is captured relatively larger in the display/storage region 52 than in the entire surface region 53. Therefore, in a case where the subject detection region is set to the display/storage region 52, the subject can be detected with higher accuracy than in a case where the subject detection region is set to the entire surface region 53.

The first region is the display/storage region 52, and the second region is the entire surface region 53. Therefore, it is possible to meet both the need to detect the subject present in the display/storage region 52 with high accuracy and the need to preemptively detect the subject present in the entire surface region 53 outside the display/storage region 52.

As shown in FIG. 11, the subject detection region setting unit 71 repeatedly switches the subject detection region between the display/storage region 52 and the entire surface region 53. Therefore, it is possible to increase the opportunities to meet both the need to detect the subject present in the display/storage region 52 with high accuracy and the need to preemptively detect the subject present in the entire surface region 53 outside the display/storage region 52.

As shown in FIG. 11, the subject detection region setting unit 71 switches the subject detection region to the entire surface region 53 in a case where a state in which no subject is detected continues for the first threshold value time TH1 after setting the subject detection region to the display/storage region 52. In addition, in a case where a state in which no subject is detected continues for the second threshold value time TH2 after the subject detection region is set to the entire surface region 53, the subject detection region is switched to the display/storage region 52. Therefore, it is possible to increase the opportunities to meet both the need to detect the subject present in the display/storage region 52 with high accuracy and the need to preemptively detect the subject present in the entire surface region 53 outside the display/storage region 52.

As shown in FIG. 11, the second threshold value time TH2 is different from the first threshold value time TH1. Specifically, the second threshold value time TH2 is longer than the first threshold value time TH1. Therefore, it is possible to increase the opportunities to meet the need to preemptively detect the subject present in the entire surface region 53 outside the display/storage region 52. In a case where the priority is given to the need to detect the subject present in the display/storage region 52 with high accuracy rather than to the need to preemptively detect the subject present in the entire surface region 53 outside the display/storage region 52, the first threshold value time TH1 may be set to be longer than the second threshold value time TH2.

As shown in FIGS. 12 and 13, the subject detection region setting unit 71 switches the subject detection region to the detection frame enlargement region 95 defined based on the subject detection information 82 in the previous frame in a case where the subject is detected by the subject detection unit 72. In the detection frame enlargement region 95 defined based on the subject detection information 82 in the previous frame, the probability that the subject will still be present in the detection frame enlargement region 95 in the next frame is high. Additionally, even for the same subject, the subject is captured relatively larger in the detection frame enlargement region 95 than in the entire surface region 53. Therefore, the subject can be detected with high accuracy.

As shown in FIG. 13, the detection frame enlargement region 95 is a region obtained by enlarging the detection frame 92 based on the set magnification factor, with the center CF of the detection frame 92 surrounding the subject detected in the previous frame as a reference. Therefore, the detection frame enlargement region 95 can be easily set.

As shown in FIG. 14, the subject detection region setting unit 71 switches the subject detection region from the detection frame enlargement region 95 to the entire surface region 53 in a case where the subject detection region is set to the detection frame enlargement region 95 and a state in which no subject is detected continues for the third threshold value time TH3. Therefore, in a case where the subject is no longer detected, it is possible to automatically return to a state in which the subject present in the entire surface region 53 outside the display/storage region 52 is preemptively detected.

The display/storage region image generation unit 74 performs processing of generating the display/storage region image 84 as the specific processing. Therefore, the distribution image 85 based on the display/storage region image 84 can be displayed on the display 18 or stored in the storage 25.

The surveillance camera 12 has a high necessity to detect a subject such as a suspicious person in order to perform a role of surveilling the surveillance location. Therefore, it is possible to greatly exhibit the effect of being able to detect the subject outside the display/storage region 52.

### Second Embodiment

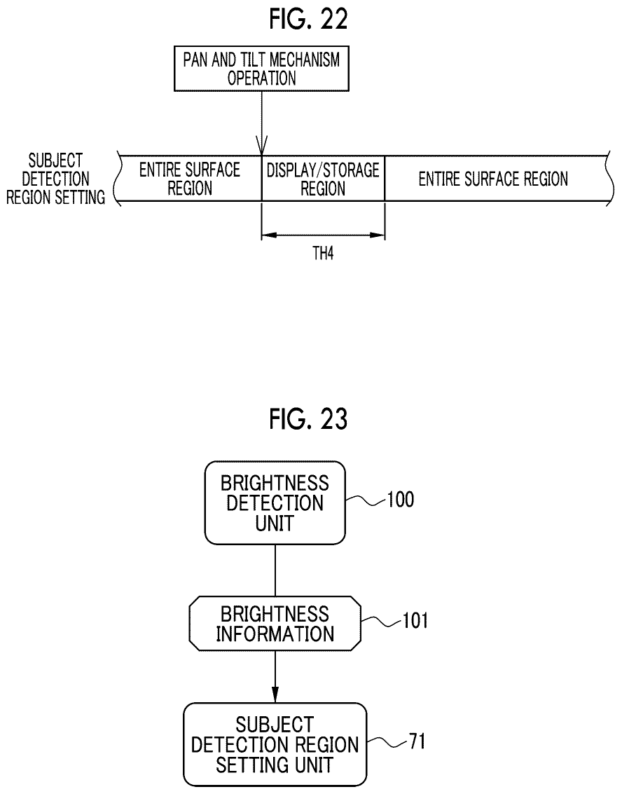

As shown in FIG. 22 as an example, in a second embodiment, the subject detection region setting unit 71 switches the subject detection region from the entire surface region 53 to the display/storage region 52 in a case where the user U operates the pan and tilt mechanism 14 while the subject detection region is the entire surface region 53. The subject detection region setting unit 71 resets the subject detection region to the entire surface region 53 in a case where the setting time of the display/storage region 52 continues for a fourth threshold value time TH4. The fourth threshold value time TH4 is stored in the storage 55 and is, for example, 1 minute.

A case where the user U operates the pan and tilt mechanism 14 mainly refers to a case where a subject of interest to the user U is present in a direction in which the pan and tilt mechanism 14 is operated. Therefore, in a case where the pan and tilt mechanism 14 is operated by the user U, the subject detection region is switched to the display/storage region 52 having a higher detection accuracy of the subject than the entire surface region 53. Accordingly, the subject of interest to the user U, which is present in the direction in which the pan and tilt mechanism 14 is operated, can be detected with high accuracy.

In a case where the zoom instruction of the surveillance camera 12 is issued by the user U, the subject detection region may be switched from the entire surface region 53 to the display/storage region 52.

### Third Embodiment

As shown in FIG. 23 as an example, in a third embodiment, the CPU 57 functions as a brightness detection unit 100 in addition to the processing units 70 to 76. The brightness detection unit 100 detects brightness of each of the display/storage region 52 and the entire surface region 53 at predetermined intervals. The brightness is, for example, an average value of brightness values obtained from the pixel values of the pixels 51 that constitute the display/storage region 52 and the entire surface region 53. The brightness detection unit 100 outputs brightness information 101 indicating the detected brightness of the display/storage region 52 and the entire surface region 53 to the subject detection region setting unit 71.

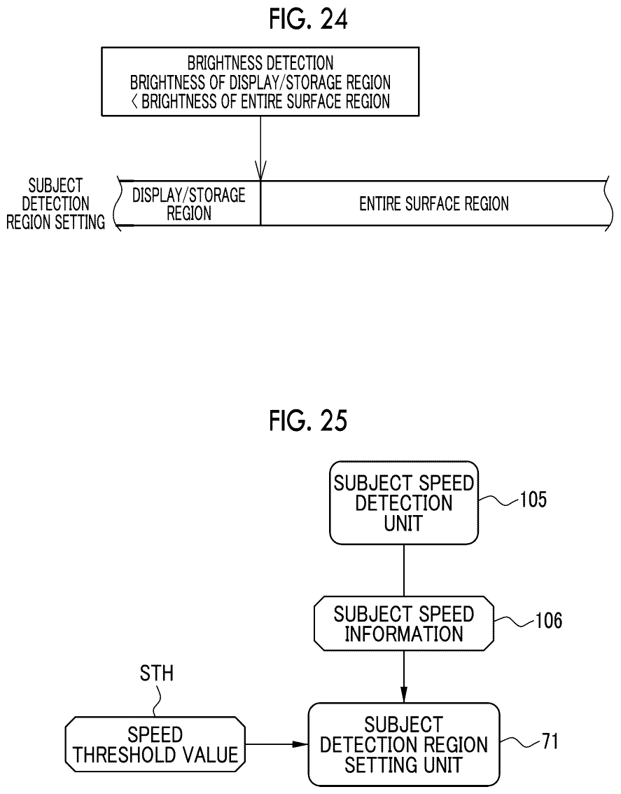

As shown in FIG. 24 as an example, the subject detection region setting unit 71 switches the subject detection region to a region having higher brightness between the display/storage region 52 and the entire surface region 53. FIG. 24 illustrates a case where the subject detection region is switched to the entire surface region 53 because the entire surface region 53 is brighter than the display/storage region 52, as a result of the brightness being detected by the brightness detection unit 100 while the subject detection region is set to the display/storage region 52. In this case, the subject can always be detected in the region having higher brightness, where subject detection accuracy is higher. For example, in a case where the display/storage region 52 is not illuminated with streetlights, but the entire surface region 53 outside the display/storage region 52 is illuminated with streetlights, switching the subject detection region to the brighter entire surface region 53 allows the detection of the subject present in the entire surface region 53 illuminated with the streetlights.

As can be seen from the second embodiment and the third embodiment described above, an aspect of repeatedly switching the subject detection region between the display/storage region 52 and the entire surface region 53 as in the first embodiment is not essential in the technology of the present disclosure. The subject detection region may be set to the entire surface region 53 by default, and the subject detection region may be switched to the display/storage region 52 only in a case where the pan and tilt mechanism 14 is operated by the user U. In addition, the subject detection region may be set to the entire surface region 53 by default, and the subject detection region may be switched to the display/storage region 52 only in a case where the display/storage region 52 is brighter than the entire surface region 53. The second embodiment and the third embodiment described above may be implemented in combination. Obviously, the first embodiment, the second embodiment, and/or the third embodiment described above may be implemented in combination.

### Fourth Embodiment

As shown in FIG. 25 as an example, in a fourth embodiment, the CPU 57 functions as a subject speed detection unit 105 in addition to the processing units 70 to 76. The subject speed detection unit 105 detects a movement speed of the subject detected by the subject detection unit 72 in the captured image 80. The subject speed detection unit 105 detects the movement speed of the subject based on, for example, the amount of change in the position of the center CF of the detection frame 92 in two consecutive frames. The subject speed detection unit 105 outputs subject speed information 106 indicating the detected movement speed of the subject to the subject detection region setting unit 71.

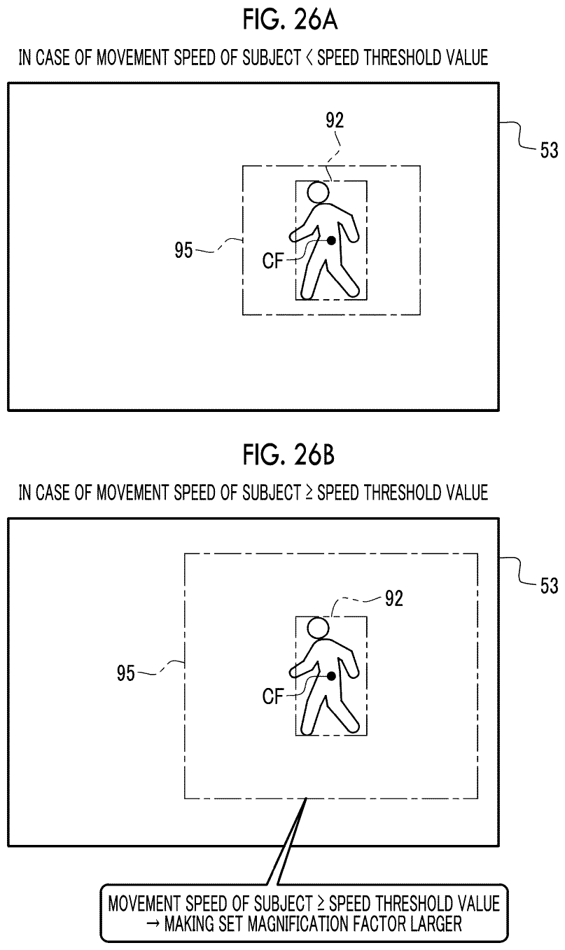

A speed threshold value STH is input to the subject detection region setting unit 71. The speed threshold value STH is stored in the storage 55. The subject detection region setting unit 71 compares the movement speed of the subject indicated by the subject speed information 106 with the speed threshold value STH. Then, as shown in FIG. 26A as an example, in a case where the movement speed of the subject is less than the speed threshold value STH, the subject detection region setting unit 71 sets the detection frame enlargement region 95 by enlarging the detection frame 92 based on the set magnification factor (vertical 1.25 times, horizontal 2.5 times) shown in FIG. 13 of the above-described first embodiment. Meanwhile, in a case where the movement speed of the subject is equal to or greater than the speed threshold value STH, the subject detection region setting unit 71 sets the detection frame enlargement region 95 by enlarging the detection frame 92 based on the set magnification factor (vertical 2 times, horizontal 4 times) that is larger than the set magnification factor (vertical 1.25 times, horizontal 2.5 times) shown in FIG. 13 of the above-described first embodiment. That is, the subject detection region setting unit 71 changes the set magnification factor of the detection frame enlargement region 95 according to the detected movement speed of the subject in the captured image 80.

In a case where the movement speed is equal to or greater than the speed threshold value STH, there is a concern that the subject in the current frame may move outside the detection frame enlargement region 95 set based on the detection frame 92 in the previous frame. Therefore, in a case where the movement speed is equal to or greater than the speed threshold value STH, the subject detection region setting unit 71 sets the detection frame enlargement region 95 at the set magnification factor that is larger than the normal set magnification factor, making it possible to reduce the likelihood of the subject moving outside the detection frame enlargement region 95 and the subject being missed in the detection.

The movement speed of the subject in the captured image 80 includes not only a movement speed in a case where the subject itself walks or runs but also a movement speed in a case where the subject appears to move due to a change in the position of the subject in the captured image 80 when the pan and tilt mechanism 14 is operated.

In a case where a state in which the movement speed is equal to or greater than the speed threshold value STH continues for a set number of frames, the set magnification factor may be changed to a larger value. In addition, in a case where a state in which the movement speed is less than the speed threshold value STH continues for the set number of frames after the set magnification factor is changed to a large value, the set magnification factor may be returned to the original small value.

The set magnification factor may be changed in three or more stages, such as setting the set magnification factor to a value smaller than the normal value in a case where the movement speed of the subject is less than a first speed threshold value, setting the set magnification factor to the normal value in a case where the movement speed of the subject is equal to or greater than the first speed threshold value and less than a second speed threshold value, and setting the set magnification factor to a value larger than the normal value in a case where the movement speed of the subject is equal to or greater than the second speed threshold value.

The “processing related to display” may be processing of performing control of displaying the display/storage region image 84 on a display unit such as the display 18. Similarly, the “processing related to storage” may be processing of performing control of storing the display/storage region image 84 in a storage unit such as the storage 25.

The “specific processing” includes not only the “processing related to display” and the “processing related to storage” described as an example, but also all processing performed on the captured image 80 other than the subject detection processing. In addition, the “specific processing” may not be the same processing for each frame.

In a case where the display/storage region 52 is set as the subject detection region and the subject detection region image 90 generated by the subject detection region setting unit 71 is the display/storage region image 84, the display/storage region image 84 may be output from the subject detection region setting unit 71 to the distribution image generation unit 75 and used to generate the distribution image 85. In this case, the display/storage region image generation unit 74 is not operated.

The centroid of the region of the subject is not limited to the center CF of the detection frame 92 described as an example. The centroid of the region of the subject may be a centroid of a polygonal shape surrounding the subject.

Although the display/storage region 52 is exemplified as the first region, the technology of the present disclosure is not limited thereto. Any of a display region on the display 18 or a storage region in the storage 25 may be used as the first region. The display region also includes a cutout region by electronic zoom. Additionally, a region that is slightly smaller or larger (for example, by several pixels) than the display/storage region 52 may be used as the first region. Further, the detection frame enlargement region 95 has been exemplified as the third region, but the technology of the present disclosure is not limited thereto. The detection frame 92 itself may be used as the third region.

Although a case where the display/storage region 52, which is the first region, and the entire surface region 53, which is the second region, are both rectangular and have the same shape has been exemplified, the technology of the present disclosure is not limited thereto. The first region and the second region may have different shapes, such as the first region being circular or elliptical and the second region being rectangular.

The display/storage region 52 may not be a region having the same size, shape, and position in each frame, and for example, the size, shape, and position may be different for each set frame.

The subject is not limited to the person P described as an example. The subject may be an animal such as a deer, a wild boar, a monkey, a bear, or a bird, or a vehicle such as a car, a train, or an airplane. It is preferable to change the set magnification factor of the detection frame enlargement region 95 according to the type of the subject, such as making the horizontal magnification larger than the vertical magnification in a case where the subject is a car.

The subject has been detected using the subject detection model 67, but the technology of the present disclosure is not limited thereto. The subject may be detected using well-known pattern recognition techniques.

In each of the above-described embodiments, the surveillance camera 12 has been described as an example of an “imaging apparatus” according to the technology of the present disclosure, but the technology of the present disclosure is not limited thereto. Instead of the surveillance camera 12, a digital camera, a smartphone, a tablet terminal, or the like used by a general user may be used. In addition, an electronic endoscope may be used.

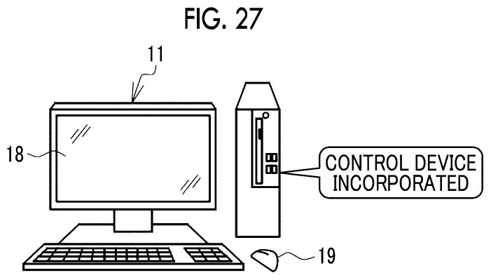

In each of the above-described embodiments, an aspect in which the controller 44 corresponding to the “control device” according to the technology of the present disclosure is provided in the surveillance camera 12 has been exemplified, but the technology of the present disclosure is not limited thereto. As shown in FIG. 27 as an example, the “control device” according to the technology of the present disclosure may be provided in the management apparatus 11. Alternatively, the “control device” according to the technology of the present disclosure may have functions provided through distribution between the management apparatus 11 and the surveillance camera 12.

In each of the above-described embodiments, for example, as a hardware structure of processing units that execute various types of processing, such as the image processing unit 70, the subject detection region setting unit 71, the subject detection unit 72, the timing unit 73, the display/storage region image generation unit 74, the distribution image generation unit 75, the distribution control unit 76, the brightness detection unit 100, and the subject speed detection unit 105, the following various processors can be used. The various processors include, as mentioned above, as well as a general-purpose processor such as the CPU 57, which executes software (operation program 65) to function as various processing units, a programmable logic device (PLD) such as a field programmable gate array (FPGA), which is a processor whose circuit configuration can be changed after manufacturing, a dedicated electrical circuit having a custom-designed circuit configuration for executing specific processing such as an application-specific integrated circuit (ASIC), and the like.

One processing unit may be composed of one of these various processors or composed of a combination of two or more processors of the same or different types (for example, a combination of a plurality of FPGAs and/or a combination of a CPU and an FPGA). Additionally, a plurality of processing units may be configured with a single processor.

As an example of configuring a plurality of processing units with a single processor, first, there is an aspect in which one or more CPUs are combined with software to configure a single processor, and the processor functions as a plurality of processing units, as represented by computers such as clients and servers. Second, there is an aspect in which a processor is used to implement the functions of the entire system, including a plurality of processing units, with a single integrated circuit (IC) chip, as represented by a system-on-chip (SoC) and the like. In this way, the various processing units are configured using one or more of the above-described various processors as the hardware structure.

Further, as the hardware structure of these various processors, more specifically, electrical circuitry obtained by combining circuit elements, such as semiconductor elements, can be used.

From the above description, the technology described in the following supplementary claims can be understood.

### Supplementary Claim 1

A control device that performs subject detection processing and specific processing on a captured image obtained from an imaging element, the control device comprising:
a processor,
in which the processor is configured to:
   set a subject detection region where the subject detection processing is performed and a specific region where the specific processing is performed, for the captured image; and
   switch the subject detection region between a first region defined based on the specific region and a second region that is different from the first region in at least one of a size, a shape, or a position.

### Supplementary Claim 2

The control device according to Supplementary claim 1,
in which the second region has a larger region size than the first region.

### Supplementary Claim 3

The control device according to Supplementary claim 2,
in which the first region is the specific region, and the second region is an effective region of an imaging surface of the imaging element.

### Supplementary Claim 4

The control device according to any one of Supplementary claims 1 to 3,
in which the processor is configured to:
   repeatedly switch the subject detection region between the first region and the second region.

### Supplementary Claim 5

The control device according to Supplementary claim 4,
in which the processor is configured to:
   switch the subject detection region to the second region in a case where a state in which no subject is detected continues for a first threshold value time after setting the subject detection region to the first region; and
   switch the subject detection region to the first region in a case where a state in which no subject is detected continues for a second threshold value time after setting the subject detection region to the second region.

### Supplementary Claim 6

The control device according to Supplementary claim 5,
in which the second threshold value time is different from the first threshold value time.

### Supplementary Claim 7

The control device according to Supplementary claim 6,
in which the second threshold value time is longer than the first threshold value time.

### Supplementary Claim 8

The control device according to any one of Supplementary claims 1 to 7,
in which the control device is provided in a surveillance camera system including a pan mechanism, and
the processor is configured to:
   switch the subject detection region from the second region to the first region in a case where the pan mechanism is operated while the subject detection region is the second region.

### Supplementary Claim 9

The control device according to any one of Supplementary claims 1 to 8,
in which the processor is configured to:
   acquire brightness information indicating brightness of the first region and the second region; and
   switch the subject detection region to a region having higher brightness between the first region and the second region.

### Supplementary Claim 10

The control device according to any one of Supplementary claims 1 to 9,
in which the processor is configured to:
   in a case where a subject is detected in the subject detection region, switch the subject detection region to a third region defined based on a detection result of the subject in a previous frame.

### Supplementary Claim 11

The control device according to Supplementary claim 10,
in which the third region is a region obtained by enlarging a region of the subject detected in the previous frame based on a set magnification factor, with a centroid of the region of the subject detected in the previous frame as a reference.

### Supplementary Claim 12

The control device according to Supplementary claim 11,
in which the processor is configured to:
   change the set magnification factor according to a movement speed of the detected subject in the captured image.

### Supplementary Claim 13

The control device according to any one of Supplementary claims 10 to 12,
in which the processor is configured to:
   switch the subject detection region from the third region to the second region in a case where the subject detection region is set to the third region and a state in which no subject is detected continues for a third threshold value time.

### Supplementary Claim 14

The control device according to any one of Supplementary claims 1 to 13,
in which the processor is configured to:
   perform, as the specific processing, at least one of processing related to display of an image of the specific region on a display unit or processing related to storage of the image of the specific region in a storage unit.

### Supplementary Claim 15

An imaging apparatus comprising:
the control device according to any one of Supplementary claims 1 to 14.

### Supplementary Claim 16

The imaging apparatus according to Supplementary claim 15, which is a surveillance camera.

### Supplementary Claim 17

A display apparatus comprising:
the control device according to any one of Supplementary claims 1 to 14.

### Supplementary Claim 18

The display apparatus according to Supplementary claim 17, which is a management apparatus of a surveillance camera system.

The technology of the present disclosure can also be appropriately combined with various embodiments and/or various modification examples mentioned above. Additionally, it is obvious that the technology of the present disclosure is not limited to each of the above-described embodiments and various configurations can be employed without departing from the gist. Furthermore, the technology of the present disclosure extends not only to the program but also to a storage medium that stores the program in a non-transitory manner.

The described contents and the shown contents provided above are detailed descriptions of portions related to the technology of the present disclosure and are merely examples of the technology of the present disclosure. For example, the descriptions regarding the above-described configuration, function, operation, and effect are descriptions regarding one example of the configuration, function, operation, and effect of the portions related to the technology of the present disclosure. Therefore, it goes without saying that, within the scope that does not depart from the gist of the technology of the present disclosure, unnecessary portions may be deleted, new elements may be added, or replacement may be made with respect to the described contents and the shown contents provided above. Additionally, in order to avoid confusion and facilitate understanding of the portions related to the technology of the present disclosure, descriptions regarding common general knowledge and the like that do not require special descriptions for enabling the implementation of the technology of the present disclosure have been omitted from the described contents and the shown contents provided above.

In this specification, “A and/or B” is synonymous with “at least one of A or B”. That is, “A and/or B” means that A may be used alone, B may be used alone, or a combination of A and B may be used. Moreover, in this specification, the same concept as “A and/or B” is also applied to a case where three or more matters are expressed by “and/or”.

All documents, patent applications, and technical standards described in this specification are incorporated in this specification by reference to the same extent as in a case where each individual document, patent application, and technical standard were specifically and individually stated to be incorporated by reference.

What is claimed is:

1. A control device comprising:
a processor,
wherein the processor is configured to:
set a subject detection region where a subject detection processing is performed and a specific region where a specific processing is performed, for the captured image; and
switch the subject detection region between a first region defined based on the specific region and a second region that is different from the first region in at least one of a size, a shape, or a position.

2. The control device according to claim 1,
wherein the second region has a larger region size than the first region.

3. The control device according to claim 2,
wherein the first region is the specific region, and the second region is an effective region of an imaging surface of an imaging element.

4. The control device according to claim 1,
wherein the processor is configured to:
repeatedly switch the subject detection region between the first region and the second region.

5. The control device according to claim 4,
wherein the processor is configured to:
switch the subject detection region to the second region in a case where a state in which no subject is detected continues for a first threshold value time after setting the subject detection region to the first region; and
switch the subject detection region to the first region in a case where a state in which no subject is detected continues for a second threshold value time after setting the subject detection region to the second region.

6. The control device according to claim 5,
wherein the second threshold value time is different from the first threshold value time.

7. The control device according to claim 6,
wherein the second threshold value time is longer than the first threshold value time.

8. The control device according to claim 1,
wherein the control device is provided in a surveillance camera system including a pan mechanism, and
the processor is configured to:
switch the subject detection region from the second region to the first region in a case where the pan mechanism is operated while the subject detection region is the second region.

9. The control device according to claim 1,
wherein the processor is configured to:
acquire brightness information indicating brightness of the first region and the second region; and
switch the subject detection region to a region having higher brightness between the first region and the second region.

10. The control device according to claim 1,
wherein the processor is configured to:
in a case where a subject is detected in the subject detection region, switch the subject detection region to a third region defined based on a detection result of the subject in a previous frame.

11. The control device according to claim 10,
wherein the third region is a region obtained by enlarging a region of the subject detected in the previous frame based on a set magnification factor, with a centroid of the region of the subject detected in the previous frame as a reference.

12. The control device according to claim 11,
wherein the processor is configured to:
change the set magnification factor according to a movement speed of the detected subject in the captured image.

13. The control device according to claim 10,
wherein the processor is configured to:
switch the subject detection region from the third region to the second region in a case where the subject detection region is set to the third region and a state in which no subject is detected continues for a third threshold value time.

14. The control device according to claim 1,
wherein the processor is configured to:
perform, as the specific processing, at least one of processing related to display of an image of the specific region on a display unit or processing related to storage of the image of the specific region in a storage unit.

15. An operation method of a control device, the operation method comprising:
setting a subject detection region where a subject detection processing is performed and a specific region where a specific processing is performed, for a captured image; and
switching the subject detection region between a first region defined based on the specific region and a second region that is different from the first region in at least one of a size, a shape, or a position.

16. A non-transitory computer-readable storage medium storing an operation program causing a computer to perform a process comprising:
setting a subject detection region where a subject detection processing is performed and a specific region where a specific processing is performed, for a captured image; and
switching the subject detection region between a first region defined based on the specific region and a second region that is different from the first region in at least one of a size, a shape, or a position.

17. An imaging apparatus comprising:
the control device according to claim 1.

18. The imaging apparatus according to claim 17, which is a surveillance camera.

19. A display apparatus comprising:
the control device according to claim 1.

20. The display apparatus according to claim 19, which is a management apparatus of a surveillance camera system.
